(19) United States
(12) Patent Application Publication
(10) Pub. No.: US 2006/0206484 A1
(43) Pub. Date: Sep. 14, 2006

(54) Method for preserving consistency between worm file attributes and information in management servers

(75) Inventor: Junichi Hara, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/080,065

(22) Filed: Mar. 14, 2005

(51) Int. Cl. G06F 17/30

(52) U.S. Cl. 707/8

(57) ABSTRACT

The present invention provides methods to preserve consistency between WORM file attributes in WORM volumes in file server systems. When a user commits a file in a WORM volume to WORM state, some file attributes can be changed before or after committing the file to WORM state so that anyone or predetermined users can read the file. In addition, access to committed WORM files can be selectively permitted.

### BACKGROUND OF THE INVENTION

The invention is related generally to file servers and in particular to file servers having Write-Once-Read-Many (WORM) data storage.

Presently, many companies are using WORM data storage to meet regulatory compliance or to protect their critical data from accidental or intentional alteration or deletion. Widely used WORM implementations are based on media technology such as tapes, optical platters, etc. However, these media have physical limitations in maximum storage size, which are not enough to keep the data handled in conventional fault-tolerant (e.g. RAID-based) disk storage. For example, a line of software products by Network Appliance, Inc. called SnapLock Compliance provide WORM-like data permanence using magnetic disk drives in a available RAID configuration.

U.S. Application No. 2004/0186858A1 by McGovern et al., incorporated herein by reference, describes a solution to address these limitations. They disclose a technique to employ conventional fault-tolerant disk storage as a platform for a WORM storage system. Their system is organized around WORM storage volumes that contain files that, when committed to WORM storage, cannot be deleted or modified. Any attempt to modify the file attributes, write to the file, or delete the file, by clients, administrators or other entities is rejected.

However, file attributes typically include information that is managed in external servers. Consequently, the consistency between the file attributes and the information in external servers will be lost if the information in external servers is deleted or modified. For example, the file attributes contains the ID number of the user owning the file. In a system where the mapping between the ID number and the user is usually managed in external authentication server, the file may be unable to be read by anybody when the mapping between the ID number and the user is deleted or modified on the authentication server. This presents a potential problem if file access is later desired.

### SUMMARY OF THE INVENTION

The present invention provides methods to preserve consistency between WORM file attributes in WORM volumes in file server systems. In accordance with one aspect of the present invention, when a user commits a file in a WORM volume to WORM state, some file attributes are changed before committing the file to WORM state so that anyone or predetermined users can read the file. In accordance with another aspect of the present invention, when a user tries to read a WORM file in a WORM volume, or when a user tries to change the ownership of a WORM file, the action is allowed if the user has the special authority for WORM files. In accordance with yet another aspect of the present invention, when a user tries to change file attributes of a WORM file, the action is allowed only if the attributes the user is trying to change are access permissions for “READ” and “EXECUTE”. In accordance with still another aspect of the present invention, when a user commits a file in WORM volume to WORM state, the OWNER ID and the GROUP ID in the attributes of the file is communicated to one or external authentication servers, thus preserving the mapping for the user ID and the group ID. In still yet another aspect of the present invention, when a user tries to read a WORM file, the user (original user) is mapped to another user (mapped user). Access is permitted if the mapped user has the authority to read even if the original user does not have authority.

### BRIEF DESCRIPTION OF THE DRAWINGS

Aspects, advantages and novel features of the present invention will become apparent from the following description of the invention presented in conjunction with the accompanying drawings, wherein:

FIG. 1 shows a generalized block diagram of the present invention as embodied in a storage system;

FIG. 2 shows a functional view of the block diagram of FIG. 1;

FIG. 3 shows the file structure of a file system;

FIG. 4 shows the organization of an inode;

FIG. 5 shows the organization of a file system;

FIG. 6 shows a process flow for performing authenticated I/O;

FIG. 7 shows a process flow for performing a read operation;

FIG. 8 shows a process flow for a changing access attributes of a WORM-committed file;

FIG. 9 shows a process flow for changing the ownership of a WORM-committed file;

FIG. 10 shows a process flow for committing a file to the WORM state;

FIG. 11 shows a process flow for changing the ownership of a WORM-committed file;

FIG. 12 shows a process flow for reading a WORM-committed file;

FIG. 13 shows a process flow for changing access permissions of a WORM-committed file;

FIG. 14 shows a process flow for committing a file to the WORM state;

FIG. 15 shows a user ID mapping table;

FIG. 16 shows a group ID mapping table; and

FIG. 17 shows a process flow for reading a WORM-committed file.

### DESCRIPTION OF THE SPECIFIC EMBODIMENTS

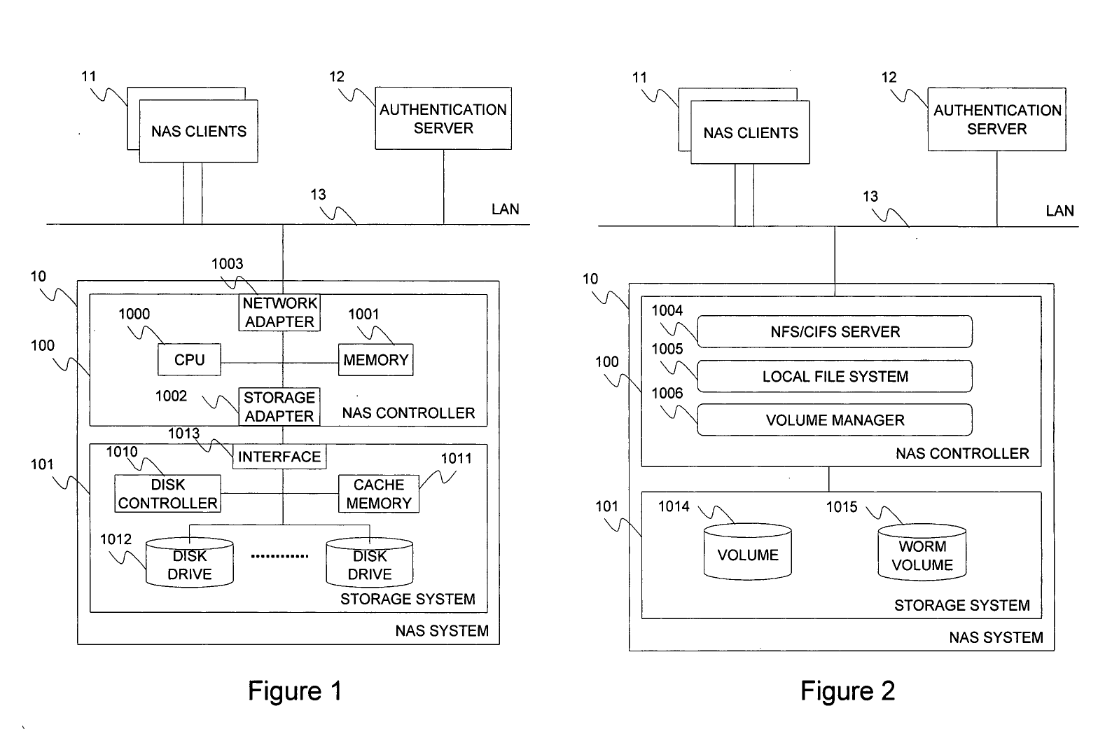

FIG. 1 shows an example of a Network Attached Storage (NAS) system in which the methods in this invention are applied. NAS System 10 is composed of NAS Controller 100 and Storage System 101. NAS controller 100 comprises CPU 1000, Memory 1001, Storage Adapter 1002, and Network Adapter 1003. NAS Controller 100 is connected to Storage System 101 via Storage Adapter 1002, and is also connected via Network Adapter 1003 with other host computers, such as NAS Clients 11 and Authentication Server 12. The programs realizing the methods in this invention run in NAS controller 100 using CPU 1000 and Memory 1001.

Storage System 101 comprises Disk Controller 1010, Cache Memory 1011, and Disk Drives 1012. Disk Controller 1010 organizes one or more groups of Redundant Array of Inexpensive Disks (RAID), which are called “physical volumes” here.

NAS Clients 11 issue file operation requests via LAN 13.

Authentication Server 12 manages user information so that the information can be shared across the clients and can be easily managed. The user information on the Authentication Server 12 contains username, password, corresponding user ID, group ID of the group that the user belongs to, etc. If Authentication Server 12 receives an authentication request from a NAS Client 11, it checks if the usemame and the password sent from the NAS Client 11 matches the record on it. If they matched, it sends back the user ID and group ID to the NAS Client 11.

FIG. 2 shows a functional diagram of the NAS System in FIG. 1. In NAS Controller 100, there are NFS/CIFS Server 1004, Local File System 1005, and Volume Manager 1006. NFS/CIFS Server 1004 receives and interprets file system protocol (e.g. NFS or CIFS) messages from NAS Clients 11, and issues appropriate file I/O requests to Local File System 1005. Local File System 1005 receives file I/O requests from NFS/CIFS Server 1004, and processes them. Volume Manager 1006 creates one or more Volumes 1014 using one or more physical volumes in Storage System 12. The Volume Manager also creates one or more WORM Volumes 1015 in the Local File System that contain files which cannot be deleted or modified when committed to WORM state.

The conventional notion of “committing” a file to the WORM state is described, for example, in U.S. Application No. 2004/0186858. A file that is committed to the WORM state possesses a characteristic of a WORM file, namely, that the file cannot be written but only read even though it is stored in a conventional read/writable storage system. Commitment of a file to the WORM state is typically achieved by clearing the write bits (or write attributes) of the file. Other mechanisms for indicating that the file is read-only are possible.

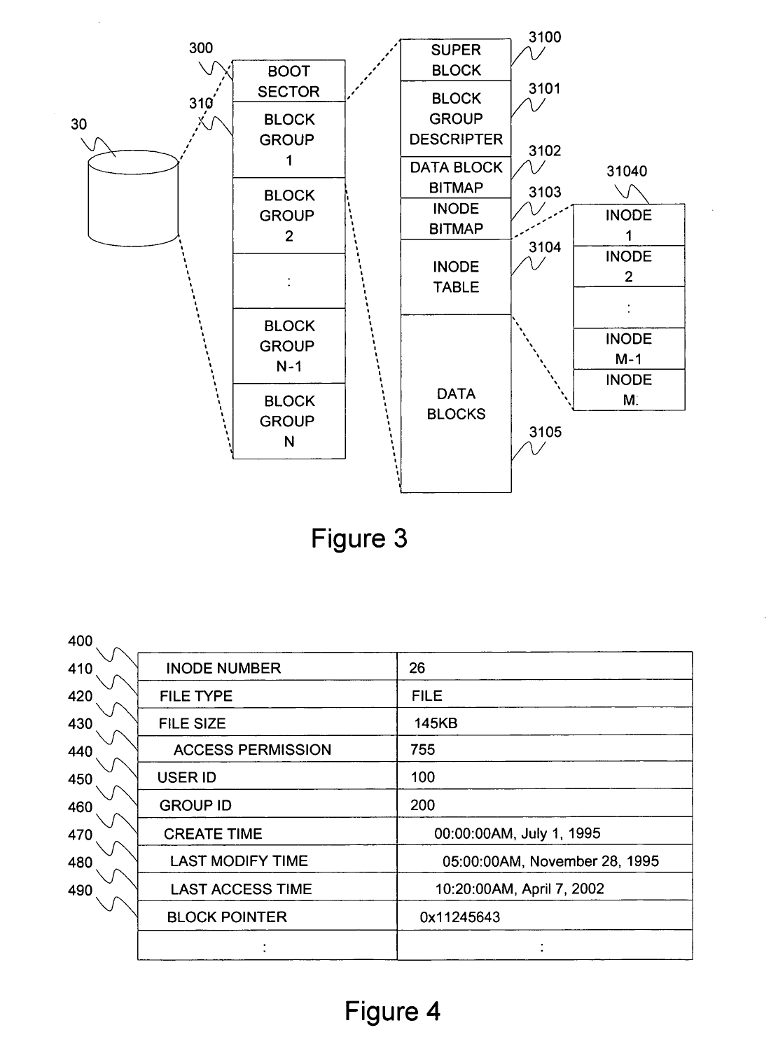

FIG. 3 shows how the data needed for Local File System 1005 is stored in Volume 1014 and WORM Volume 1015, identified in FIG. 3 as a generic volume 30. Boot Sector 300 is usually used to store programs to boot the System if needed. Local File System 1005 does not change the data in Boot Sector 300. In this invention, Boot Sector 300 can be used to indicate if the volume contains WORM files or not. The rest of the volume is used by Local File System 1005.

Local File System 1005 divides the rest of the volume into Block Groups 310. Each Block Group 310 contains Super Block 3100, Block Group Descriptor 3101, Data Block Bitmap 3102, inode Bitmap 3103, inode Tables 3104, and Data Blocks 3105.

Super Block 3100 is used to store the location information of Block Groups 310. Every Block Group 310 has the same copy of Super Block 3100. Block Group Descriptor 3101 stores the management information of the Block Group 310. Data Block Bitmap 3102 shows which Data Blocks 3105 are in use. In a similar manner, inode Bitmap 3103 shows which Inodes 31040 in inode Table 3104 are in use.

FIG. 4 shows the kind of data each inode 31040 in inode Table 3104 has. Each inode 31040 stores attributes of each file or directory such as:

inode Number 400: The unique number for the inode.

File Type 410: What the inode is used for (file, directory, etc).

File Size 420: The size of the file.

Access permission 430: Bit string expressing access permissions for user (owner), group, other.

User ID 440: ID number of the user owning the file.

Group ID 450: ID number of the group that the user (owner) belongs to. One or more users can be associated with the group.

Create Time 460: The time when the file is created.

Last Modify Time 470: The time when the file is modified.

Last Access Time 480: The time when the file is last accessed.

Block Pointer 490: Pointer to the data blocks where actual data is stored.

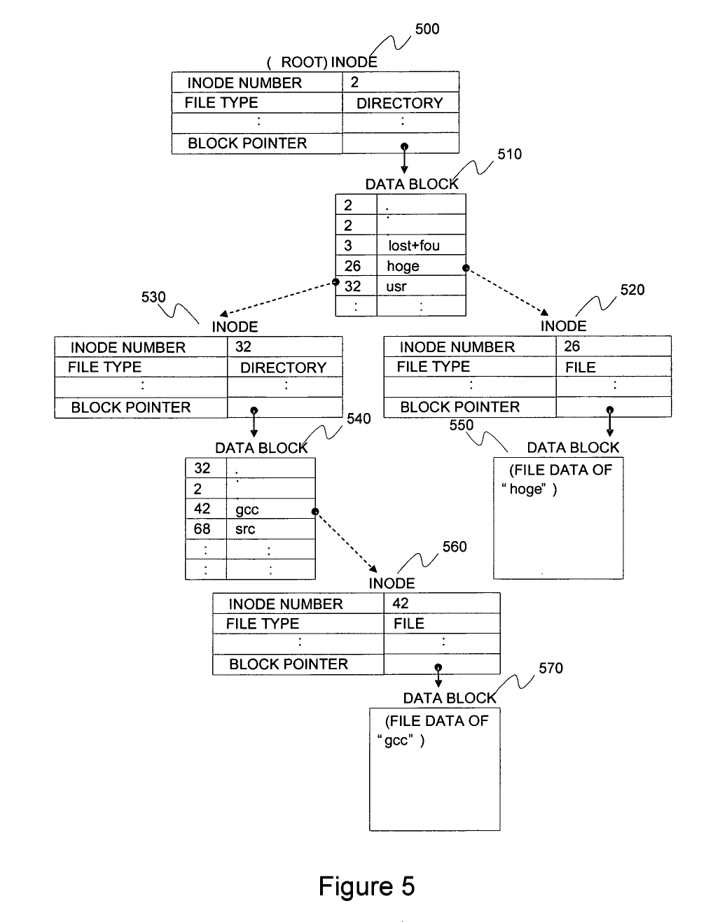

FIG. 5 shows the logical relationship between Inodes 31040 and Data Blocks 3105. Each inode can be used to indicate a file or a directory. If the inode indicates a file (if its File Type field is “file”, like 520 and 560), the data block pointed from the inode contains actual data of the file. If a file is stored in a plurality of Disk Blocks 310 (such as ten), the addresses of the ten Disk Blocks 310 are recorded in Block Pointer 490. Each Block Pointer 490 is expressed as the logical block address (LBA) in Volume 1014 or WORM Volume 1015. If the inode indicates a directory (if the File Type field is “directory”, like root inode 500 or some lower level directory Inodes, 530), the Data Blocks 3105 pointed from Block Pointer 490 stores the list of inode Numbers 400 and Names of all files and directories in the directory; e.g., data blocks 510 and 540.

Volume Manager 1006 creates and manages two kinds of volume: normal volumes and WORM volumes. Files in the normal volumes are treated as conventional files in conventional file system, which means any files in the normal volumes can be deleted or modified by users who have appropriate authority. But as discussed above, files in the WORM volumes that are committed to the WORM state cannot be deleted or modified by anybody. Here, we refer to such files as “WORM files”. Committing a file to WORM state is accomplished by removing all WRITE permissions for the file (changing the file state to read-only).

Normal volumes and WORM volumes can be distinguished by, for example, placing a WORM flag in empty space in Boot Sector 300 in each volumes. By this means, NAS System 10 can easily examine if a file is in WORM state or not by checking the WORM flag in Boot Sector 300 and the access permissions 430 in inode of each file.

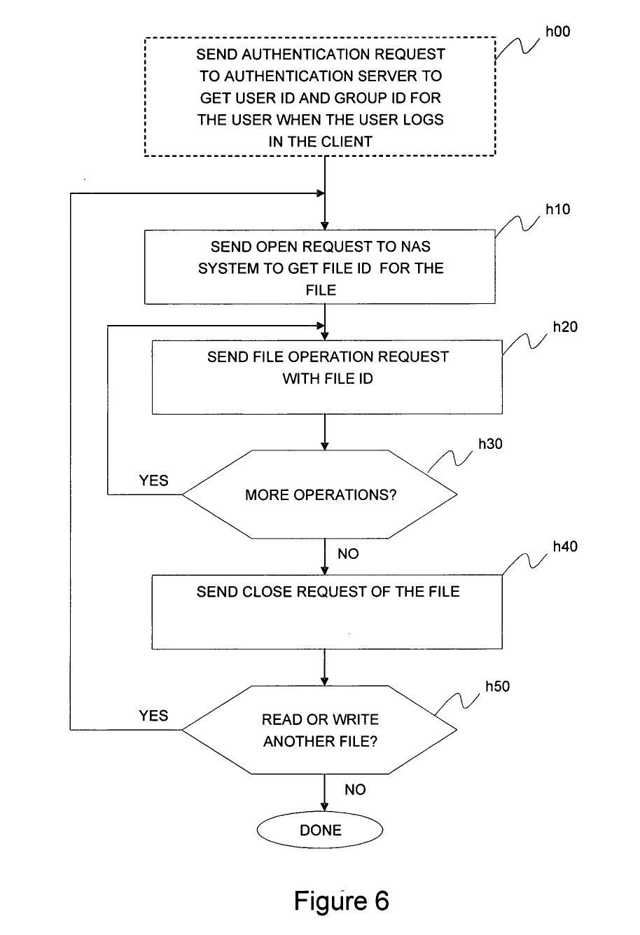

FIG. 6 shows the flow diagram of accessing a file in NAS System 10 from NAS Clients 11. When a user on a NAS Client 11 wants to access a file on NAS System 10, the user has to be authenticated by the Authentication Server 12 to get the user ID and the group ID beforehand (Step h00). The authentication is done when the user logs in the NAS Client 11. When the user tries to log in, the NAS Client 11 sends the username and the password input by the user to the Authentication Server 12, and if the username and the password matches the records on the Authentication Server 12, the Authentication Server 12 returns the user ID corresponding to the username and the group ID of the group the user belongs to.

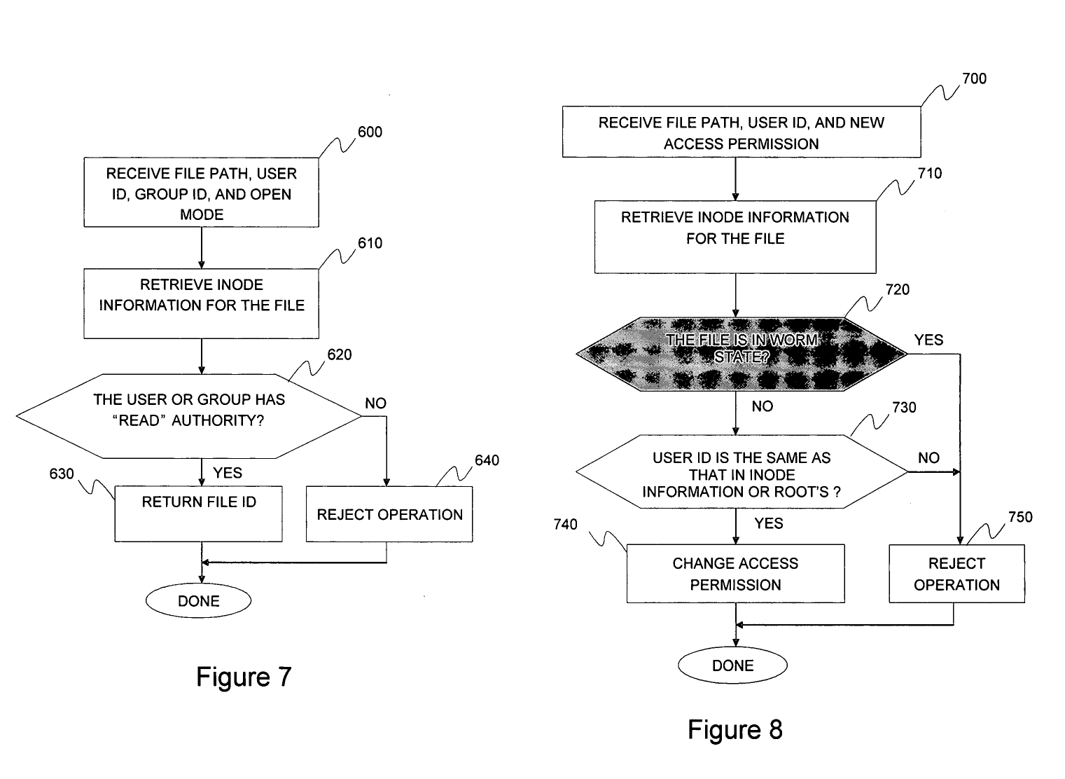

After the user logs in the NAS Client 11, when the user tries to access a file on the NAS System 10, the NAS Client 11 first sends an OPEN request for the file to the NAS System 10 (Step h10). FIG. 7 shows the flow diagram of processing OPEN request in NAS System 10. The received OPEN request contains file path, the user ID, the group ID, and “open mode”, step 600. The inode corresponding to the file is obtained in a step 610. The open mode indicates what kind of operations the NAS Client 11 is going to do after opening the file. If the open mode is “read-only”, the NAS System 10 permits an OPEN request and returns (step 630) a file ID for the file to the client only if the user or the group has READ permission for the file, step 620. In case of reading a file, it does not matter if the user ID or the group ID has WRITE permission for the file. If permission is denied, then the operation is rejected in step 640.

Returning to FIG. 6, after getting the file ID in response to the OPEN request, the NAS Client 11 sends file operation requests such as READ and WRITE for the file to the NAS System 10 with the file ID (h20). The same file ID can be used as long as the target file of operation requests is the same. When all the file operation is done, the NAS client 11 sends a CLOSE request for the file (h30, h40). The NAS System 10 makes the file ID invalid in response to the CLOSE request.

In CIFS protocol, OPEN request is issued using commands like SMB_COM_OPEN or SMB_COM_OPEN_AND_X, and CLOSE request using SMB_COM_CLOSE or SMB_COM_CLOSE_AND_TREE_DISC. In NFS protocol, it depends on its version what kind of commands are used to get file IDs. In NFS version 4 (NFSv4), there are OPEN and CLOSE commands. But in NFS version 2 and 3 (NFSv2 and v3), there aren't commands for OPEN and CLOSE requests. Thus, the flow diagram will be slightly different from FIG. 6. The flow diagrams here show only in case of CIFS and NFSv4.

For the purpose of reference, in NFSv2 and v3, NAS Clients 11 use LOOKUP command to get a file ID. Then, the NAS Clients 11 also get file attributes (some information in inode 31040) in response to the LOOKUP command from the NAS System 10. The NAS Clients 11 (instead of NAS System 10) checks if a user has a right authority to open a file in reference to the file attributes. And even when all the operations are done, NAS clients 11 don't send CLOSE request.

In conventional NAS Systems, only the super user “root”, whose user ID is 0, and the owner of the file, whose user ID is the same as that in the inode of the file, are allowed to change access permissions 430. In NAS Systems having a feature of WORM data storage, the same rules are applied for files which are in normal volumes, and files which are in WORM volumes but not committed to WORM state yet. But for the WORM files (the files committed to WORM state), nobody is allowed to change access permissions 430. Committing a file to WORM state is accomplished by removing all the WRITE permissions for the file.

FIG. 8 shows the flow diagram of changing access permissions of a file or a directory in WORM volumes. In a step 700, information relating to the file is received. Its inode is retrieved in a step 710. A check is made in a step 720 whether the file is in the WORM state. If it is, then the change attempt is rejected in a step 750. If the file has not been committed to the WORM state, then in a step 730 a check is made whether the user ID is root or matches the UID in the inode. If there is not match, then the change attempt is rejected. Otherwise, the access permission is effected in a step 740.

In conventional NAS Systems, only the super user “root” is allowed to change ownership of files. Changing ownership of a file is to change the user ID in the inode of the file. In NAS Systems having a feature of WORM data storage, anybody (even “root”) cannot change ownership of WORM files.

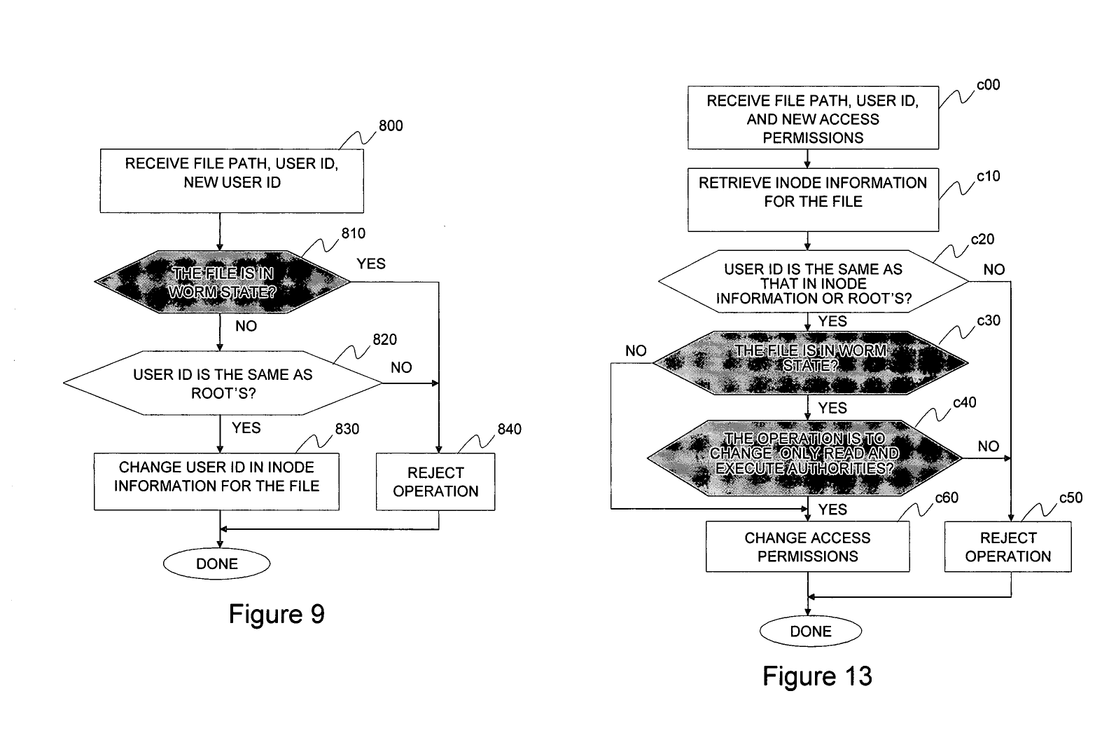

FIG. 9 shows the flow diagram of changing ownership of a file or a directory in WORM volumes. In a step 800, information relating to the file is received. A check is made in a step 810 whether the file is in the WORM state. If it is, then the change attempt is rejected in a step 840. If the file has not been committed to the WORM state, then in a step 820 a check is made whether the user ID is root. If the user is not root, then the change attempt is rejected. Otherwise, the user ID in the inode is changed in a step 830.

In accordance with a first embodiment of the present invention, some of the inode information is changed when a file is committed to WORM state so that the file can be read by anybody or by predetermined user or users. Thus in accordance with this embodiment of the present invention, a novel process of “committing” a file to the WORM state is disclosed which differs from the conventional notion of “committing” a file to the WORM state.

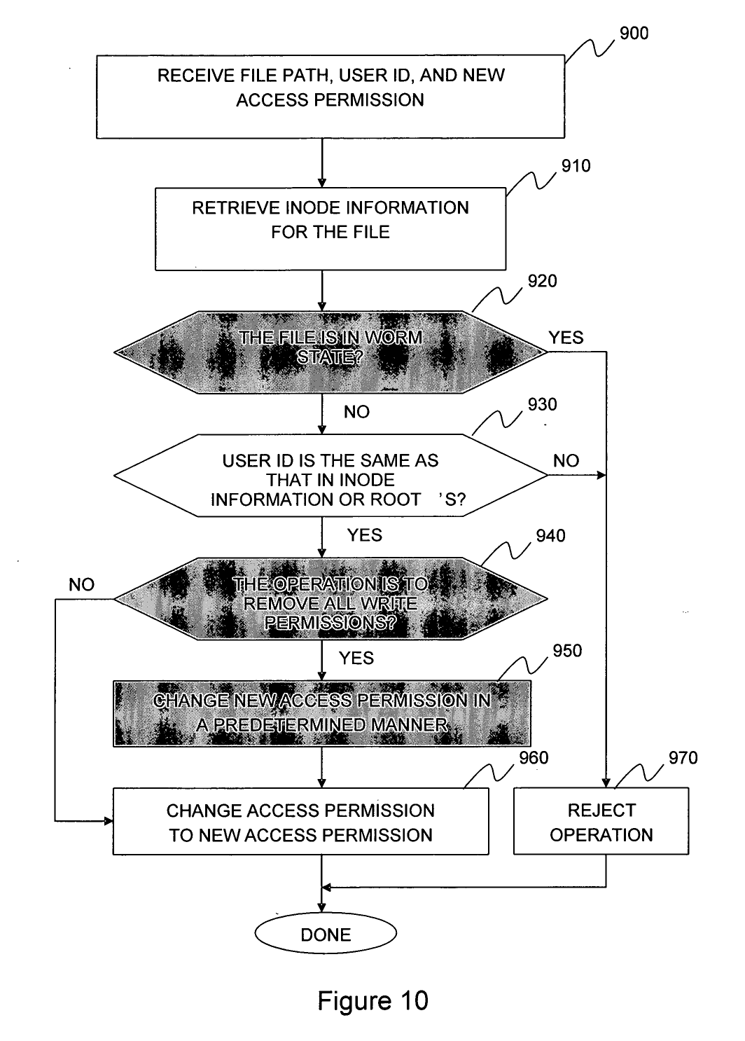

FIG. 10 shows the flow diagram for changing access permissions of a file or a directory according to this aspect of the invention. In a step 900, information relating to the file is received via a request to change the access permission(s) of the file. Its inode is retrieved in a step 910. A check is made in a step 920 whether the file is in the WORM state. If it is, then the change attempt is rejected in a step 970. If the file has not been committed to the WORM state, then in a step 930 a check is made whether the user ID in the request is root or matches the UID in the inode. This user ID in the request identifies the user who issued the request If the user ID is not root and does not match the user ID of the inode, then the change attempt is rejected. If the user is valid, then a check is made in a step 940 whether the access permissions are being changed to remove all write permissions (indicating an attempt to commit the file to the WORM state). If all the write permissions are being removed (i.e., commit to WORM state), then in a step 950, the new access permission received in step 900 is changed in a predetermined manner:

Change READ permission for “other” users to 1 (allow) so that the file can be read by anybody irrespective of the mapping information on authentication server 12.

Change READ permission for “group” to 1 (allow) so that the file can be read by the users in the same group even if the mapping information for the current owner is deleted or modified on the authentication server 12.

Change READ permission for “owner” to 1 (allow) and user ID to predetermined user ID so that the user IDs that must not be deleted or modified on the authentication server 12 can be narrowed down.

If in step 940 it is determined that the file is not being committed to the WORM state, then the access permission is changed to the new access permission, in a step 960.

Two or more of above can be applied at the same time. Predetermined user IDs can be stored, for example, in empty space of Boot Sector 300 of WORM volumes. After step 950 is performed, then removal of the write permission is effected by performing step 960.

In accordance with a second embodiment of the present invention, a “special” user is created for WORM files who can read or change ownership under any circumstances. The information about the “special” user (e.g., the user ID of the special user) can be stored, for example, in Boot Sector 300 of each WORM volume. This can be performed by the administrator of the NAS System 10. It is also possible to define a “special” group ID so that any user whose group ID is in that “special” group can read or change ownership of files committed to the WORM state.

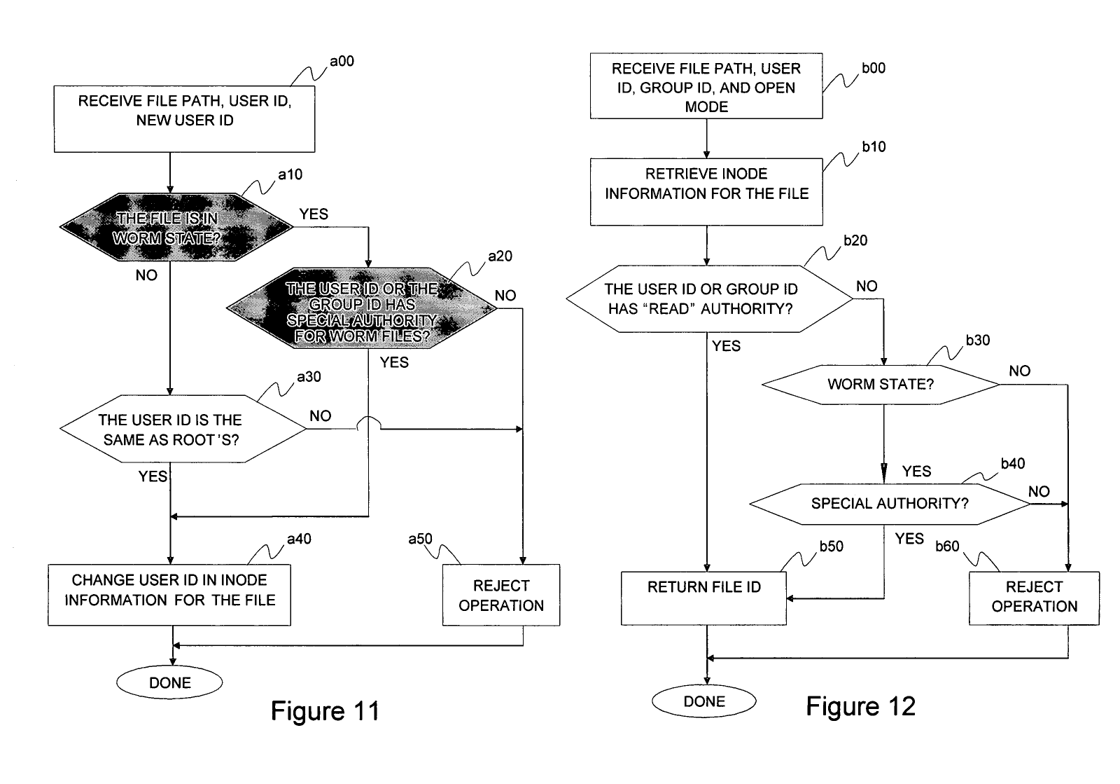

FIG. 11 shows the flow diagram of changing ownership of a file in accordance with this embodiment. In a step a00, information relating to the file is received via a request to change the ownership of the file. A check is made in a step a10 whether the file is in the WORM state. If the file has not been committed to the WORM state, then in a step a30 a check is made whether the user ID (in the request) is root. If the user is not root, then the change attempt is rejected in a step a50. Otherwise, the user ID in the inode is changed according to the request, in a step a40.

Returning to the decision step a10, if the file has been committed to the WORM state, then a check is made in a step a20 whether the user ID or the group ID is a predetermined ID, or belongs to a list of predetermined IDs. These predetermined IDs represent special user(s) or special group(s) who can change characteristics of a file that is committed to the WORM state, such as access permissions and ownership. If the user or group ID is not a predetermined user or group ID, then the request is rejected in step a50. Otherwise the request is performed in step a40.

FIG. 12 shows the flow diagram of opening a file to be read. As shown in FIG. 12, when Local File System 1005 receives (step b00) a request to open a file, the corresponding inode is retrieved (step b10). A check is made in a step b20 whether the user has the right authority to read the file by checking the Access Permissions 430 in the inode of the file. This step includes checking if the user is root. If the user has read authority then the open is performed in a step b50 by returning the file ID.

If the user does not have the right authority, a check is made if the file is in WORM state (step b30). If the file is in WORM state, a check is made whether the user ID corresponds to the special user (or belongs to a group) for WORM files (step b40); otherwise the request is rejected. If the user ID corresponds to a special user (or belongs to a special group) for WORM files, Local File System 1005 allows the operation and returns the file ID in a step b50. Thus, the special user for WORM files can read WORM files under any circumstances.

It is noted that the flows shown in FIG. 11 and in FIG. 12 can be used together in a particular embodiment of the present invention.

In accordance with a third embodiment of the present invention, the owner can be permitted to change READ and EXECUTE permission for WORM files so that the access permissions can be changed by the owner in case the mapping information on the authentication server is deleted or modified. Here, changing WRITE permission for WORM files must not be permitted, as doing so would be contrary to the basic characteristics of WORM-committed files.

FIG. 13 shows the flow diagram of changing access permission of a file or a directory according to this embodiment. In a step c00, information relating to the file is received via a request to change the access permission. Its inode is retrieved in a step c10. A check is made in a step c20 whether the user ID is root or matches the UID in the inode. If not, then the request is rejected in a step c50. If the user ID is root or matches the UID in the inode, then a check is made in a step c30 whether the file is in the WORM state. If not, then the access permission as requested is effected in a step c60. If the file is a WORM-committed file, then in a step c40 a check is made whether the access permission being changed are only read and/or execute permissions. If not match, then the change attempt is rejected. Otherwise, the access permission is effected in a step c60. Thus, even if the file is in a WORM-committed state, the operation is allowed if it changes only the READ and EXECUTE permissions. This allows the owner of the file to change READ and EXECUTE permission for WORM-committed files under any circumstances.

In accordance with a fourth embodiment of the present invention, notification of user IDs of owners of WORM files is sent to authentication server when files are committed to WORM state. The authentication server can then lock the mapping information for the user IDs to prevent it from subsequent modification or deletion.

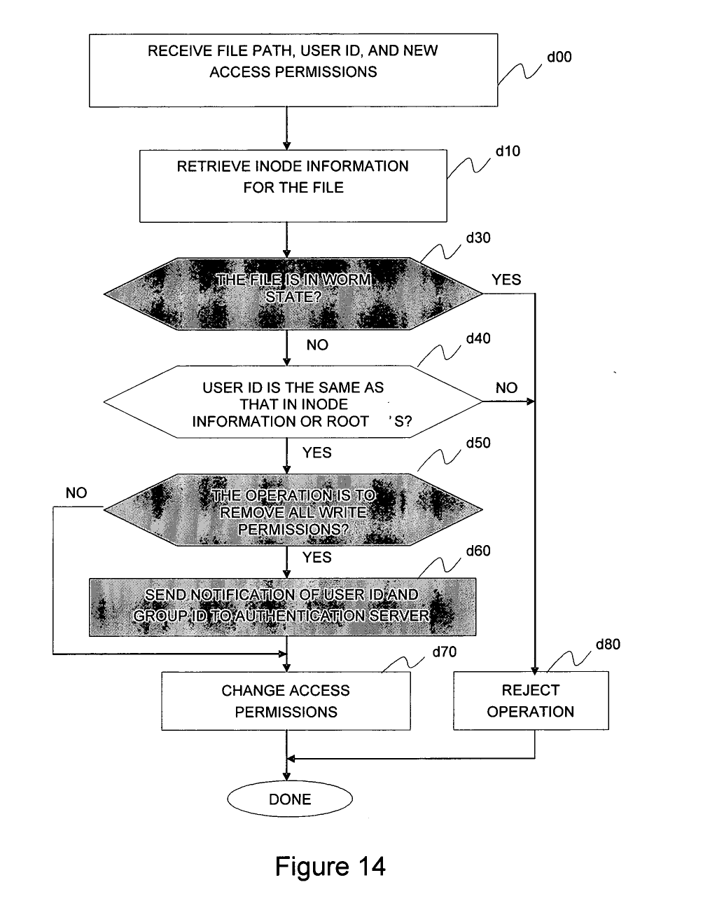

FIG. 14 shows the flow diagram of changing access permission of a file or a directory according to this embodiment of the present invention. In a step d00, information relating to the file is received. Its inode is retrieved in a step d10. A check is made in a step d30 whether the file is in the WORM state. If it is, then the change attempt is rejected in a step d80. If the file has not been committed to the WORM state, then in a step d40 a check is made whether the user ID is root or matches the UID in the inode. If the user ID is not root and does not match the user ID of the inode, then the change attempt is rejected. If the user is valid, then a check is made in a step d50 whether the access permissions are being changed to remove all write permissions (indicating an attempt to commit the file to the WORM state). If so, then in a step d60 a notification is sent to the authentication server 12. The notification contains at least the user ID of the owner of the file. After receiving the notification, the authentication server 12 locks the mapping information for the user ID in its information base. Next, the access permission is changed according to request, in a step d70.

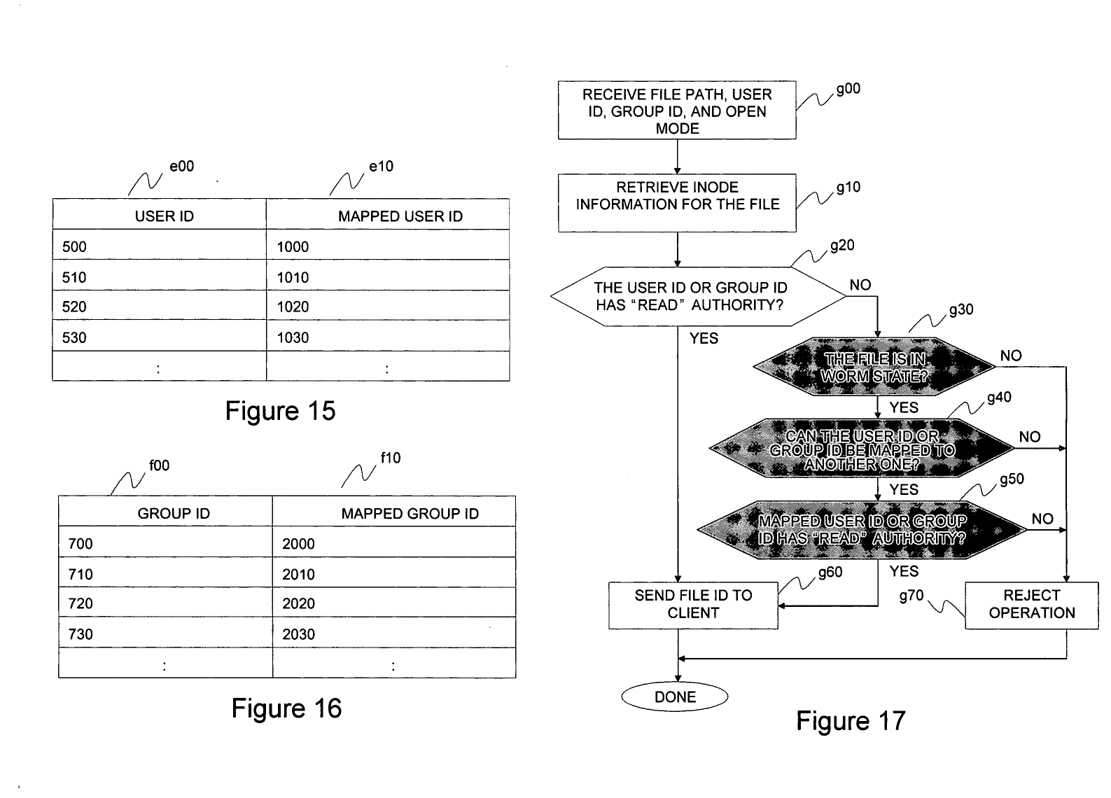

In accordance with a fifth embodiment of the present invention, there is mapping information of user IDs and group IDs in NAS System 10. The mapping information of user IDs and group IDs is registered by the administrator of NAS System 10. Thus, even when the mapping information for a user ID of a user on the authentication server 12 is modified, and the user gets another user ID, Local File System 1005 can realize the user is the same by checking the mapping information in NAS System 10. And even when it's deleted, Local File System 1005 can realize the files that the user owns are relegated to another user by checking the information. FIG. 15 shows the example of mapping information which maps user IDs (e00) to mapped user IDs (e10). FIG. 16 shows a mapping of group IDs (f10) to mapped group IDs (f10).

FIG. 17 shows the flow diagram of opening a file to read according to this embodiment of the present invention. When Local File System 1005 receives (step g00) a request to open a file, the corresponding inode is retrieved (step g10). A check is made in a step g20 whether the user has proper authority to read the file by checking the Access Permissions 430 in the inode of the file. If the user has read authority then the read is performed in a step g60 by returning the file ID.

If the user does not have the right authority, a check is made if the file is in WORM state (step g30). If the file is in WORM state, a check is made in a step g40 whether the user can be mapped to either a mapped user or to mapped group; otherwise the request is rejected at step g70. If the user can be mapped, then a check is made in a step g50 whether the mapped user has read authority; otherwise the request is rejected. If the mapped user has the authority to read, the Local File System 1005 allows the operation (step g60).

The mapping of a user involves the table of FIG. 15 or of FIG. 16. With respect to FIG. 15, an attempt is made to map the user ID to a mapped user ID by looking for the user ID in the e00 field and obtaining the corresponding mapped user ID in the e10 field. Similarly, an attempt is made to map the group ID of the user to a mapped group ID by looking for the user's group ID in the field f00 and obtaining the corresponding mapped group ID in the f10 field.

What is claimed is:

1. In a storage system having a operating a WORM (write-once, read many) storage component, a method for operating the storage system comprising:
receiving a commit request to commit a file to a WORM state, the file being associated with an owner of the file, the file further being associated with a write attribute that specifies whether write operations can be performed on the file, the file further being associated with a read attribute that specifies whether read operations can be performed on the file;
in response to receiving the commit request, changing the write attribute of the file in a manner that no subsequent write operations can be performed on the file; and
further in response to receiving the commit request, performing one of:
changing the read attribute of the file in a predetermined manner that only predetermined users can subsequently access the file for reading; or
transmitting a notification to a computer system separate from the storage system, the notification including information indicative of the owner of the file.

2. The method of claim 1 wherein the read attribute is changed in a manner to permit subsequent read access by any user.

3. The method of claim 1 wherein the file is further associated with a group identifier, the group identifier being associated with one or more users, wherein the read attribute is changed in a manner to permit subsequent read access by any user associated with the group identifier.

4. The method of claim 1 further including changing the owner of the file to a second owner, wherein the read attribute is changed in a manner to permit subsequent read access only for the second owner.

5. The method of claim 1 wherein the file is further associated with a group identifier, the group identifier being associated with one or more users, wherein the read attribute include a first read access attribute for the owner, a second read access attribute for the group, and a third read access attribute for users other than the owner and the users associated with the group identifier.

6. The method of claim 1 wherein the computer system is an authentication server.

7. A storage system comprising a plurality of physical disk drives, one or more first disk drives from among the plurality of physical disk drives being configured to store a plurality of files, one of more second disk drives from among the plurality of physical disk drives being configured to store a plurality of WORM-committed files, the storage system operative to perform the method recited in claim 1.

8. A method for a storage system comprising a WORM storage component, the method comprising:
receiving commit requests to commit files to a WORM state thus creating a plurality of WORM-committed files, the WORM-committed files each being associated with a user ID and a group ID, the user ID indicative of a file owner, the group ID indicative of a group to which the file owner belongs, the WORM-committed files each further being associated with read access attributes;
receiving an attribute request to change an attribute of a first WORM-committed file, the attribute request being associated with a first user, the first user being associated with a group; and
if the first user belongs to a list of predetermined users, or if the first user is associated with a group that belongs to a list of predetermined groups, then changing the attribute of the first WORM-committed file according to the attribute request,
wherein if the first user does not belong to the list of predetermined users and if the first user does not belong to one of the predetermined groups, then the attribute request is not serviced.

9. The method of claim 8 wherein the attribute request is a request to change ownership of the first WORM-committed file.

10. A storage system comprising a plurality of physical disk drives, one or more first disk drives from among the plurality of physical disk drives being configured to store a plurality of files, one of more second disk drives from among the plurality of physical disk drives being configured to store a plurality of WORM-committed files, the storage system operative to perform the method recited in claim 8.

11. The storage system of claim 10 configured as a NAS (network attached storage) system.

12. A method for a storage system comprising a WORM storage component, the method comprising:
receiving commit requests to commit files to a WORM state thus creating a plurality of WORM-committed files, the WORM-committed files each being associated with a user ID and a group ID, the user ID indicative of a file owner, the group ID indicative of a group to which the file owner belongs, the WORM-committed files each further being associated with read access attributes;
receiving an attribute request to change an attribute of a first WORM-committed file, the attribute request being associated with a first user, the first user being associated with a group; and
changing the attribute of the first WORM-committed file according to the attribute request,
wherein the attribute request is a request to change either a read access permission of the first WORM-committed file or an execute access permission of the first WORM-committed file.

13. A storage system comprising a plurality of physical disk drives, one or more first disk drives from among the plurality of physical disk drives being configured to store a plurality of files, one of more second disk drives from among the plurality of physical disk drives being configured to store a plurality of WORM-committed files, the storage system operative to perform the method recited in claim 12.

14. The storage system of claim 13 configured as a NAS (network attached storage) system.

15. A method for a data storage system having a WORM storage component comprising:
storing a plurality of WORM-committed files, each having associated therewith a user ID;
receiving a read request to read a first WORM-committed file, the read request having associated therewith a user ID; and
if the user ID that is associated with the read request belongs to a predetermined ID, or if the user identified by the user ID that is associated with the read request belongs to a predetermined group, then servicing the read request.

16. The method of claim 15 wherein servicing the read request includes transmitting a file identifier that identifies the first WORM-committed file.

17. The method of claim 15 further comprising consulting a user ID mapping table comprising a plurality of user IDs, wherein if the user ID that is associated with the read request is in the user ID mapping table, then servicing the read request.

18. The method of claim 15 further comprising consulting a group ID mapping table comprising a plurality of group IDs, wherein the user identified by the user ID that is associated with the read request is associated with a group ID, wherein if the user's group ID is in the group ID mapping table, then servicing the read request.

19. A storage system comprising a plurality of physical disk drives, one or more first disk drives from among the plurality of physical disk drives being configured to store a plurality of files, one of more second disk drives from among the plurality of physical disk drives being configured to store a plurality of WORM-committed files, the storage system operative to perform the method recited in claim 15.

20. The storage system of claim 19 configured as a NAS (network attached storage) system.
